(19) United States
(12) Patent Application Publication
(10) Pub. No.: US 2017/0132405 A1
(43) Pub. Date: May 11, 2017

(54) COMMAND, DATA AND DEVICE PROVENANCE USING LOCATION-SPECIFIC SIGNATURES

(71) Applicant: Roger R. Dube, Pittsford, NY (US)

(72) Inventor: Roger R. Dube, Pittsford, NY (US)

(73) Assignee: Digital Authentication Technologies, Inc., Boca Raton, FL (US)

(21) Appl. No.: 15/192,887

(22) Filed: Jun. 24, 2016

Related U.S. Application Data
(60) Provisional application No. 62/184,035, filed on Jun. 24, 2015.

(51) Int. Cl. G06F 21/44; G06F 21/57

(52) U.S. Cl. CPC G06F 21/44; G06F 21/57; G06F 2221/034

(57) ABSTRACT

An invention is provided for establishing the provenance of data, devices, and commands. The invention includes collecting contextual information characterizing a specific location during a first time period utilizing a contextual data collection device. A contextual location fingerprint is then created based on the collected contextual information. Later, such as when data is to be created and transferred to another system, new contextual information is collected at the location occupied by data to be verified during a second time period, such as during installation. A certificate of provenance is generated utilizing the collected new contextual information, and embedded into the data. Later, for example during installation, the information within the certificate of provenance is compared to the CLF, and authenticated if the information is within predefined parameters of the CLF.

### CROSS REFERENCE TO RELATED APPLICATIONS

This application claims the benefit of U.S. Provisional Patent Application having Ser. No. 62/184,035, filed on Jun. 24, 2015, and entitled “Command, Data and Device Provenance Using Location-Specific Signatures,” which is hereby incorporated by reference.

### BACKGROUND OF THE INVENTION

1. Field of the Invention

This invention relates generally to authentication of a remote electronic devices and software, and more specifically, to command, data and device provenance using location-specific signatures.

2. Description of the Related Art

The provenance (i.e., determining the source of computer related hardware, software, and/or electronic communication to ascertain whether it is genuine or counterfeit) of processing systems in high value environments such as banking, healthcare, infrastructure control, and defense systems and communication, is essential in establishing a trusted computing environment. The introduction of malware into a processor's boot loading software and subsequent system check can render the entire platform susceptible to hacking, spying and malicious activity.

Security and privacy are major concerns in today's computing environment. The fear of unauthorized access to sensitive information continues to grow throughout both the private and business sectors. This fear is further heightened by the possibility of the introduction of various types of malware that will continue to mine sensitive information long after the unauthorized access has been terminated. These concerns are even more pronounced when the trusted compute pool is distributed across countries with different judicial, regulations, and data security and privacy laws. Password and proximity sensing are insufficient in preventing such access.

Therefore, there is an urgent need for a new authentication system that can establish the provenance of a device and can be used during the manufacture and initialization of devices such as (but not limited to) processors, Trusted Platform Modules (TPMs), disk drives, authentication hardware, system control, infrastructure control, defense systems (including command, control and communication) and more.

### SUMMARY OF THE INVENTION

Broadly speaking, embodiments of the present invention address these needs by establishing the provenance (i.e., the authentication and assurance of the origin) of command, data, software, and hardware devices using contextual data utilizing unique location signatures at the moment of instantiation of these classes of information.

In one embodiment, a method for establishing the provenance of data is disclosed. The method includes collecting contextual information characterizing a specific location during a first time period utilizing a contextual data collection device (CDCD), wherein the contextual information indicates specific characteristics of the location and is collected at the location. A contextual location fingerprint (CLF) is then created based on the collected contextual information, wherein the CLF is a data space of values mapped over specific period of time. Later, such as when data is to be created and transferred to another system, new contextual information is collected at the location occupied by data to be verified during a second time period, such as during installation. A certificate of provenance is generated utilizing the collected new contextual information, and embedded into the data. Later, for example during installation, the information within the certificate of provenance is compared to the CLF. The data is then authenticated if the information is within predefined parameters of the CLF. The data can be, for example, a software update. A portion of the contextual information can include RF measurement data acquired using dual frequency measurements of dielectric content of intervening material, and the contextual information can be mapped over time to create the CLF. In one aspect, certificate of provenance can be provided to other servers for authentication.

In a further embodiment, a method for establishing the provenance of hardware is disclosed. The method includes collecting contextual information characterizing a specific location during a first time period utilizing a contextual data collection device (CDCD), wherein the contextual information indicates specific characteristics of the location and is collected at the location. A contextual location fingerprint (CLF) is then created based on the collected contextual information, wherein the CLF is a data space of values mapped over specific period of time. Later, such as when the hardware is created and transferred to another system, new contextual information is collected at the location occupied by hardware to be verified, such as during installation into a new system. A certificate of provenance is generated utilizing the collected new contextual information, and embedded into the hardware. Later, for example during installation hardware, the information within the certificate of provenance is compared to the CLF. The hardware is then authenticated if the information is within predefined parameters of the CLF. The hardware can be, for example, a processor. A portion of the contextual information can include RF measurement data acquired using dual frequency measurements of dielectric content of intervening material, and the contextual information can be mapped over time to create the CLF. In one aspect, certificate of provenance can be provided to other servers for authentication.

Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings in which:

FIG. 1 is a flowchart showing a method for characterizing a specific space for authentication and provenance purposes using LSDF methods, in accordance with an embodiment of the present invention;

FIG. 2 is a conceptual diagram illustrating a location signature, in accordance with an embodiment of the present invention; and

FIG. 3 is an illustration showing an exemplary software update code section including a CLF certificate of provenance, in accordance with an embodiment of the present invention.

### DETAILED DESCRIPTION OF THE PREFERRED EMBODIMENTS

An invention is disclosed for a security and access system based on multi-dimensional location characteristics. In general, embodiments of the present invention authenticate the presence of a device (such as a laptop or computer server) through the creation of a Contextual Location Fingerprint (CLF) comprising location specific contextual information. Contextual information is defined as information which can be obtained through electronic means such as line-of-site range information, acoustic reflection, radio frequency (RF) measurements and any other type of information which can only be determined at the location in question.

The present invention establishes the provenance (i.e., the authentication and assurance of the origin) of command, data, software, and hardware devices using contextual data. Embodiments of the present invention create unique location signatures at the moment of instantiation of these classes of information by measuring certain signal properties that are specific to a device's physical location within a structure. Such signals then comprise a location signature that can be appended to or otherwise subsequently queried in order to place the command, data or device at a unique location and time.

The present invention presents an implementation of the Contextual Location Fingerprint (CLF), wherein the authentication of a secure device establishes its provenance at the moment of creation and initialization. A Contextual Location Fingerprint (CLF) comprises location specific contextual information. Contextual information is defined as information which can be obtained through electronic means such as line-of-site range information, acoustic reflection, radio frequency (RF) measurements and any other type of information which can only be determined at the location in question. Using location-specific characteristics that cannot be spoofed or altered, the present invention creates a certificate of provenance that cannot be predicted by any external means, changes from moment to moment, and can only be validated by a similar CLF system operating in the actual place of origin of the device.

There are numerous examples in the physical world wherein a user can gain access to certain information only if he/she is physically in that space. A few examples include: bank customers who wish to access their safe deposit box; auditors who need to access a company's financial records; doctors who need to review patient information; government officials who need to access certain documents protected by security classification, etc.

The present invention establishes a location-based authentication of provenance of hardware, commands, data, and software using the CLF system. Requiring that a device, command, data, or software be at a specific, verifiable location at the moment of origin or manufacture to receive such a certificate of provenance adds a degree of provenance that would mirror strong control found in the physical world.

The location-based authentication of the provenance of hardware devices disclosed in the present invention preferably occurs on a real-time basis, at the time of the transaction, file creation, data access, or software installation. It should be apparent to one skilled in the art that this technology is not in any way limited to establishing the provenance of hardware devices only—the same process can be used to provide a certificate of provenance, using the CLF, of any file or electronic communication, including but not limited to emails, messages, documents, IP addresses, and other software-based quantities of information.

Moreover, the use of the CLF to establish trusted provenance information of any device or file's origins also can be used by the recipient to establish the provenance of their computer, files, etc. This establishes a two-way system of trust that employs location authentication that is not based in geo-location information and cannot be spoofed or otherwise defeated.

Contextual Location Fingerprints (CLFs) represent the superset of data obtained from Contextual Data Collection Devices (CDCDs). CDCDs are the actual devices that can obtain any type of information related to a location. Contextual information collected from electronic devices is utilized to establish a unique signature for a location which is called the Contextual Location Fingerprint. Contextual information is defined as information that can only be obtained from that location. Examples of contextual information include (but are not limited to) for example: 1) 3-D environment mapping from a single perspective, 2) Light and Sound reflective characteristics of surrounding materials, and 3) Birefringence characteristics in a multiplicity of directions extracted using radio frequency propagation through the intervening material into the space. One embodiment of the present invention employs at least one Contextual Information technology whose values are modified by the materials present in the space around the user's device. It should be appreciated that, to the extent that the surrounding structure does not change significantly over time, a CLF for that location would be stable and reproducible.

Contextual information obtained in the same fashion from the same location at some later time can be statistically compared to the original CLF to establish a statistical confidence that the measurements were taken from the same location and thereby used to establish a location-based authentication of provenance of hardware, software, or and electronic communication using the CLF system.

Contextual Data Collection Devices (CDCDs) can comprise any device capable of collecting desired contextual information, and more than one CDCD can be utilized to collect contextual information forming a particular Contextual Digital Fingerprint (CDF). That is, the CDCDs are used to establish a Contextual Digital Fingerprint (CDF) for a location based on the observable characteristics of that location. Examples of contextual information include (but are not limited to): 1) Range information to key materials, such as doors, walls, ceilings, fixed appliances, ductwork, etc., 2) Range and intensity of measurable sources of energy, such as infrared beacons, sound reflection characteristics, etc, and 3) Birefringence measurements from established sources of RF.

Different types of CDCDs can exist and their utilization will depend on the operating characteristics of the location being secured. For example, a CDCD can function via technology known as Location Specific Digital Fingerprint (LSDF), as described in U.S. Pat. No. 7,177,426 to Dube, which is incorporated herein by reference. More than one type of CDCD may be employed to create a CDF as described in U.S. Pat. No. 8,533,793 to Hanna, which is incorporated herein by reference.

The Contextual Location Fingerprint (CLF) uses electronic sensors to establish contextual information about a location, e.g. a room within a building. This contextual information is then used to establish a digital fingerprint for that location which generally is unrelated to the geo-characteristics of that location.

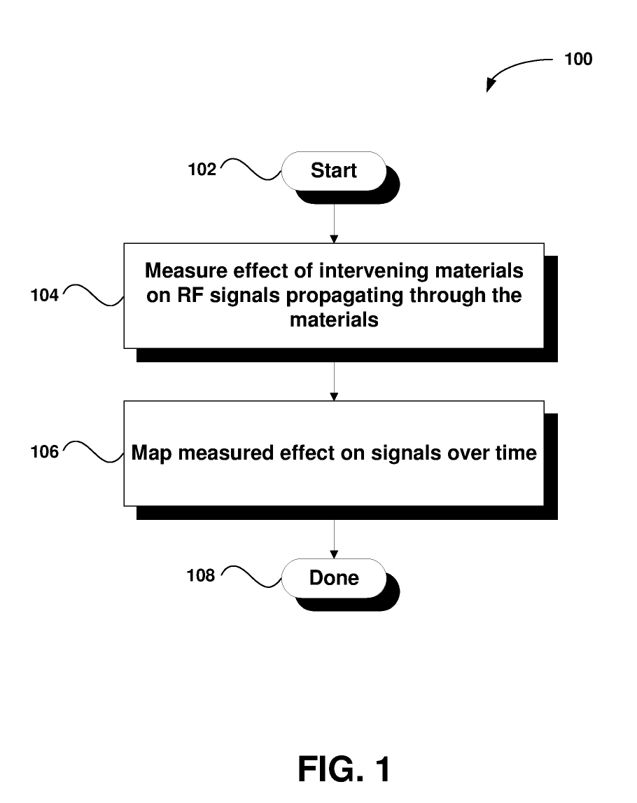

For example, FIG. 1 is a flowchart showing a method 100 for characterizing a specific space for authentication and provenance purposes using LSDF methods, in accordance with an embodiment of the present invention. In an initial operation 102, preprocess operations are performed. Preprocess operations can include, for example, determining the size of the specific space to be characterized, determining the amount of characterization data to be used, and other preprocess operations that will be apparent to those skilled in the art with the hindsight acquired after a careful reading of the present disclosure.

In operation 104 the effect the intervening materials surrounding the specific space have on RF signals propagating through the materials is measured. There are a number of methods that can be utilized to measure the effect intervening material has on RF signals propagating through the material. For example, in one method, highly precise dual frequency measurements of the dielectric content of the material are performed to measure the total electron content (TEC) of the materials by observing the effect on the dual frequency signals. In another method, the attenuation of single frequency signals due to loss by scattering is measured. Both techniques produce a unique location signature by accumulating TEC or signal strength data from radio wave-emitting satellites in orbit, such as GPS satellites. The specific choice of dual frequency TEC measurements vs. single frequency attenuation measurements can be dictated by environment, application requirements or cost, but both approaches produce unique location signature maps that will largely look the same.

Typically, several GPS satellites are within the line of sight of any place on Earth at any time. Furthermore, different satellites send signals from different directions into a room at any given moment and these directions all change as the satellites orbit. Therefore, over a period of hours, the variations in the intensities of signals from many directions can be detected and recorded, as discussed next with respect to operation 106.

The measured effect of the intervening materials on RF signals is mapped over time to create a location signature based on the measured effect of the intervening material surrounding the specific space, in operation 106. As mentioned above, over a period of hours, the variations in the intensities of signals from many directions can be detected and mapped. These variations in intensity with direction in the room can then be stored as a location signature to be compared with shorter-period signatures sent from the same location by someone requesting secure communications.

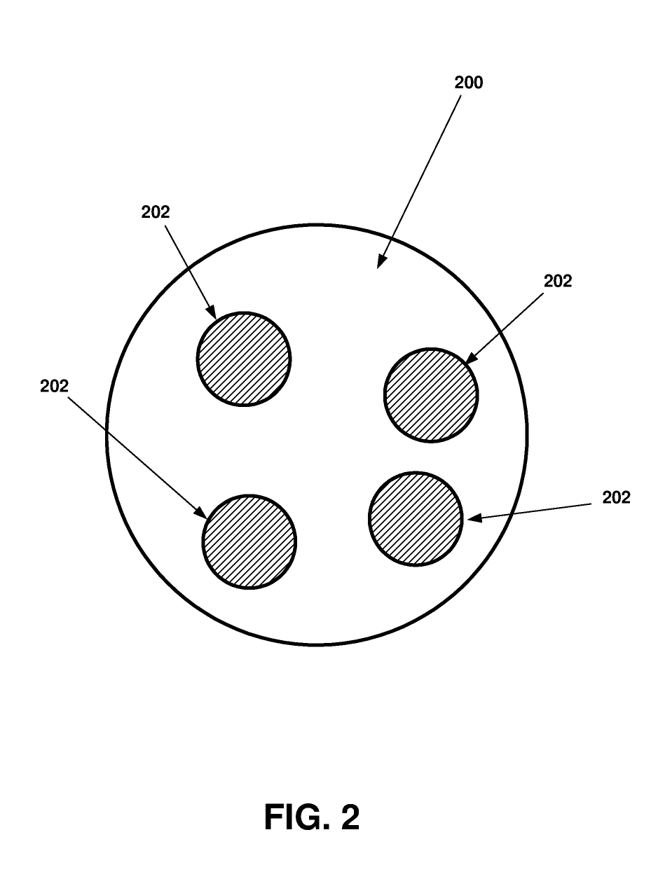

FIG. 2 is a conceptual diagram illustrating a location signature 200, in accordance with an embodiment of the present invention. In the example of FIG. 2, the location signature 200 represents the data space of values based on the measured effect of the intervening materials surrounding the specific space on RF signals mapped over time. Each RF measurement data 202 represents a smaller amount of data based on the measured effect of the intervening materials on RF signals collected over a much shorter period of time. For example, the location signature 200 can represent data collected at a receiver over a twenty-four hour period of time, while each RF measurement data 202 represents, for example, several minutes of data collected at the receiver.

Turning back to FIG. 1, post process operations are performed in operation 108. Post process operations can include, for example, storing the location signature for the specific space in a database, mapping additional specific spaces, and other post process operations that will be apparent to those skilled in the art with the hindsight acquired after a careful reading of the present disclosure.

Much like a human fingerprint, embodiments of the present invention compare measurements taken at different time intervals to confirm the measurements were taken from the same location. Unlike the aforementioned location technologies with limitations, embodiments of the present invention are: not subject to practical spoofing attempts, have a very high degree of accuracy, and are not based in any way on geo-location derived from triangulation of four or more remote satellite signals. If an attacker gains access to the raw data constituting a CLF fingerprint, the attacker is not be able to infer anything about the location on earth being secured. Thus, embodiments of the present invention are an excellent solution for government, military and commercial enterprises needing robust location authentication.

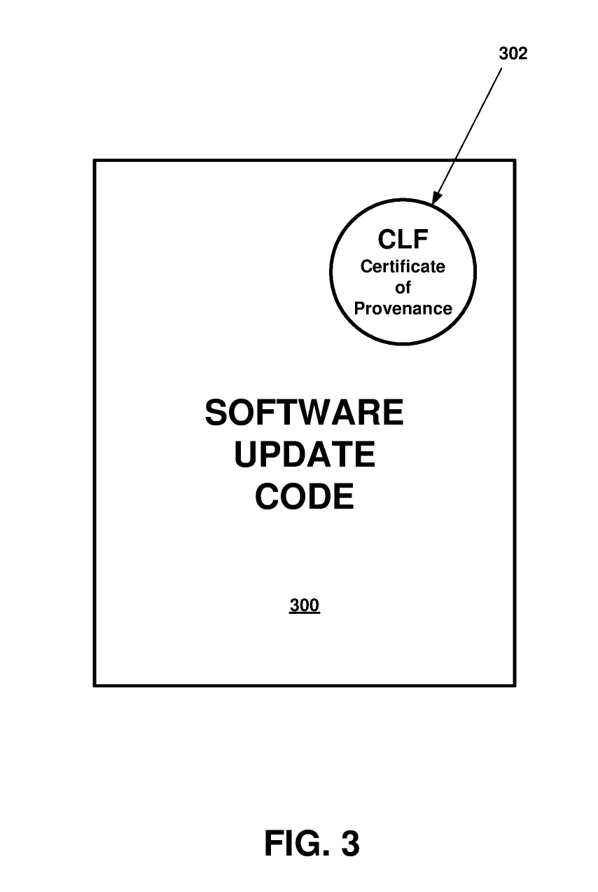

For example, FIG. 3 is an illustration showing an exemplary software update code section 300 including a CLF certificate of provenance 302, in accordance with an embodiment of the present invention. The exemplary software update code section 300 can be, for example, a software patch, operating system security update, or any other section of code designed to be installed on a computer system. The CLF certificate of provenance 302 preferably is created on a real-time basis, at the time of the software update code section 300 creation.

Prior to installing the software update code section 300, embodiments of the present invention determine whether the code section 300 includes an authenticate CLF certificate of provenance 302. This can be accomplished via a plurality of methods. For example, local data on the computer system can be checked against the CLF certificate of provenance 302 to determine its authenticity. Alternatively, or in addition, the CLF certificate of provenance 302 can be checked via a database located at a remote location, as described in greater detail in U.S. Pat. No. 8,533,793 to Hanna, which is incorporated herein by reference.

As mentioned above, malware and counterfeit products pose serious threats to all areas of electronic commerce and information technology. To defeat the threats posed by these products it is essential that the provenance of a piece of code, machinery that is to be installed in a production environment, or a credit card can be established as having a trusted source so it can be depended upon to perform as designed and expected. The CLF certificate of provenance 302 can be used to ensure these items are themselves trustworthy. Hence, a computer system should not install and run the software update code section 300 if it did not come from an approved, change managed environment. Thus, embodiments of the present invention only install production ready code when it can demonstrate it came from an approved, protected, change controlled environment via a certificate of provenance 302.

As discussed above, embodiments of the present invention can be used to establish provenance of hardware and commands. For example, a server should not be racked and connected to the network unless its provenance can be established acceptably via the embodiments of the present invention.

Malware insertion attacks remain a primary tactic of attackers. POS systems were updated with mal code to compromise the environment and extract sensitive information. Phishing attacks seek to insert malware to allow access of attackers into the environment. The advent of Stuxnet has ushered in the age of targeted malware to specific function that regularly eludes standard security controls. These attacks have been devastating to highly sensitive state-controlled industrial environments and private companies such as Target, JP Morgan Chase, Home Depot, Sony, etc.

Embodiments of the present invention provide a reliable mechanism of underpinning policy orchestration to limit what code can be placed and installed on systems to prevent their compromise by the proverbial Trojan horse while still allowing an environment to rapidly adjust to needs and not impact availability.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for establishing the provenance of data, comprising:
collecting contextual information characterizing a specific location during a first time period utilizing a contextual data collection device (CDCD), wherein the contextual information indicates specific characteristics of the location and is collected at the location;
creating a contextual location fingerprint (CLF) based on the collected contextual information, wherein the CLF is a data space of values mapped over specific period of time;
collecting new contextual information at the location occupied by data to be verified during a second time period;
generating a certificate of provenance utilizing the collected new contextual information;
embedding the certificate of provenance into the data, wherein the data is to be transferred to a separate location; and
comparing the information within the certificate of provenance to the CLF and authenticating the data if the information is within a predefined parameters of the CLF.

2. A method as recited in claim 1, wherein a portion of the contextual information includes RF measurement data acquired using dual frequency measurements of dielectric content of intervening material.

3. A method as recited in claim 1, wherein the contextual information is mapped over time to create the contextual location fingerprint (CLF).

4. A method as recited in claim 1, wherein the data is a software update.

5. A method as recited in claim 1, wherein the certificate of provenance is provided to other servers for authentication.

6. A method for establishing the provenance of hardware, comprising:
collecting contextual information characterizing a specific location during a first time period utilizing a contextual data collection device (CDCD), wherein the contextual information indicates specific characteristics of the location and is collected at the location;
creating a contextual location fingerprint (CLF) based on the collected contextual information, wherein the CLF is a data space of values mapped over specific period of time;
collecting new contextual information at the location occupied by the hardware to be verified during a second time period;
generating a certificate of provenance utilizing the collected new contextual information;
embedding the certificate of provenance into the hardware; and
comparing the information within the certificate of provenance to the CLF and authenticating the hardware during a second time period if the information is within a predefined parameters of the CLF.

7. A method as recited in claim 6, wherein a portion of the contextual information includes RF measurement data acquired using dual frequency measurements of dielectric content of intervening material.

8. A method as recited in claim 6, wherein the contextual information is mapped over time to create the contextual location fingerprint (CLF).

9. A method as recited in claim 6, wherein the hardware is a processor.

10. A method as recited in claim 7, wherein the certificate of provenance is provided to other servers for authentication.
